(19) United States
(12) Patent Application Publication
(10) Pub. No.: US 2025/0310459 A1
(43) Pub. Date: Oct. 2, 2025

(54) PROGRAM FOR EXTENDING GENERAL-PURPOSE SCANNING SOFTWARE, METHOD FOR CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: ERI OKUDA, Ibaraki (JP)

(21) Appl. No.: 19/088,457

(22) Filed: Mar. 24, 2025

(30) Foreign Application Priority Data
Mar. 27, 2024 (JP) 2024-052422

(51) Int. Cl. H04N 1/04; H04N 1/00

(52) U.S. Cl. CPC H04N 1/04; H04N 1/00408; H04N 2201/33321

(57) ABSTRACT

A non-transitory computer-readable storage medium stores an application program which causes an information processing apparatus to perform a control method, the application program supporting scanning software which is able to be used with a plurality of image processing apparatuses supplied from a plurality of manufacturers. The control method includes displaying a display screen that accepts a mixed document size setting for scanning when a feeder is specified as a document scan source, and outputting a scan instruction to an image reading device that executes scanning based on the setting accepted on the display screen.

### BACKGROUND

### Field

The present disclosure relates to a program for extending general-purpose scanning software, a method for controlling an information processing apparatus, and an information processing apparatus.

### Description of the Related Art

There is a known configuration of control software for scanning devices in which scan instructions are provided to the scanning device connected to a host computer using a scan driver installed in the host computer. An operating system (hereinafter referred to as “OS”), which serves as the basic software, is installed in the host computer. The scan driver is configured according to the specifications defined by the OS and operates when involved by the OS. The vendor (manufacturer) that provides the scanning device can provide a means for instructing the scanning device to scan using the OS by providing a scan driver conforming to the specifications of the OS.

Windows® has recently provided a standard class driver (hereinafter also referred to as “standard driver”) that can be commonly used with scanning devices provided by multiple vendors. Such a standard driver is packed in the OS package and can easily be used by connecting any scanning device to the host computer. This eliminates the need for separately installing a device-specific scan driver suitable for the scanning device, which enhances the convenience. The standard driver may be configured to allow scanning functions to be specified based on scanning function information generated from information obtained from the connected scanning device. This enables users of the standard driver to specify scanning functions according to the capabilities of the connected scanning device, even though they are using a single standard driver. However, this is limited to functions that can be implemented only by the standard driver, and therefore, it is not possible to specify functions unique to the scanner vendor.

Japanese Patent Laid-Open No. 2021-033526 discloses a program for extending the printing function of general-purpose software.

One example of the functions of scan drivers unique to the vendors of scanning devices is a mixed document size function of scanners. The mixed document size function enables a scanner to simultaneously read multiple documents of different sizes through the feeder, generating scanned image data according to the size of each scanned document. By using this function, multiple documents can be scanned without the need to reposition them on the feeder according to their sizes, thereby obtaining appropriately sized image data.

However, the standard driver does not support the mixed document size function. For this reason, the user needs to reposition the documents of different sizes during scanning according to their sizes.

The present disclosure provides a software environment that enables functions that cannot be used with standard general-purpose scanning software.

### SUMMARY

The present disclosure includes the following configuration.

A non-transitory computer-readable storage medium stores an application program which causes an information processing apparatus to perform a control method, the application program supporting scanning software which is able to be used with a plurality of image processing apparatuses supplied from a plurality of manufacturers. The control method includes displaying a display screen that accepts a mixed document size setting for scanning when a feeder is specified as a document scan source, and outputting a scan instruction to an image reading device that executes scanning based on the setting accepted on the display screen.

Further features of the present disclosure will become apparent from the following description of exemplary embodiments with reference to the attached drawings.

### BRIEF DESCRIPTION OF THE DRAWINGS

FIG. 1 is a block diagram of the whole system according to an embodiment.

FIG. 2A is a block diagram illustrating the general configuration of scanning software according to an embodiment.

FIG. 2B is a block diagram illustrating a configuration according to an embodiment in which an extending application is associated with the general-purpose scanning software and the scanning device.

FIG. 3A is a diagram of a scan-settings screen displayed by the scanning application according to a first embodiment.

FIG. 3B is a diagram of an advanced-settings screen displayed in the case of the configuration without the extending application according to the first embodiment.

FIG. 3C is a diagram of an advanced-settings screen displayed in the case of the configuration with the extending application according to the first embodiment.

FIG. 4 is a flowchart illustrating the operation of the scanning application, the general-purpose scanning software, and the extending application according to the first embodiment.

FIG. 5 illustrates capability tables of the scanning device, the general-purpose scanning software, and the extending application according to the first embodiment.

FIG. 6 is a sequence chart illustrating the operation of the scan processing according to the first embodiment.

FIG. 7 is a flowchart illustrating the operation of the extending application according to the first embodiment.

FIG. 8 is a flowchart illustrating the operation of the scanning device according to the first embodiment.

FIG. 9 is a sequence chart illustrating the operation of scan processing according to a second embodiment.

FIG. 10 is a sequence chart illustrating the operation of scan processing according to a third embodiment.

FIG. 11 is a flowchart illustrating the operation of an extending application according to the third embodiment.

### DESCRIPTION OF THE EMBODIMENTS

Embodiments of the present disclosure will be described hereinbelow with reference to the accompanying drawings. It is to be understood that the following embodiments do not limit the present disclosure according to the claims and that not all of the combinations described in the embodiments are required for the solution of the present disclosure.

### First Embodiment

### Hardware Configuration of Scanning System

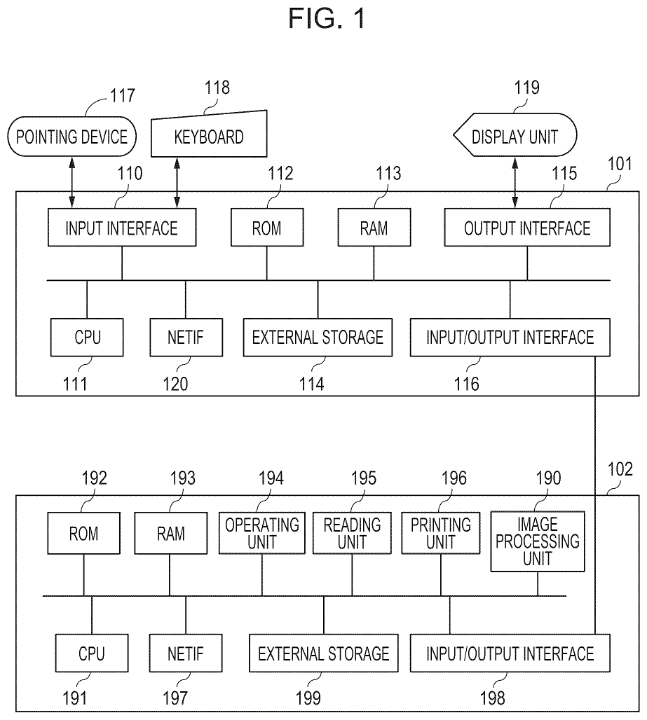

FIG. 1 is a block diagram illustrating the hardware configuration of a scanning system.

### Host Computer

A host computer 101 is an example of an information processing apparatus, which includes an input interface 110, a central processing unit (CPU) 111, a read only memory (ROM) 112, a random-access memory (RAM) 113, an external storage 114, an output interface 115, and an input/output interface 116. The input interface 110 connects to input devices including a keyboard 118 and a pointing device 117. The output interface 115 connects to a display device such as a display unit 119. A network interface (NETIF) 120 performs control for transferring data to/from an external device via a network.

The ROM 112 stores initialization programs.

The RAM 113 is used as a work memory or the like in executing various programs stored in the external storage 114 to allow the various programs to operate in the host computer 101.

Examples of the external storage 114 include a hard disk drive (HDD) and a solid-state drive (SSD). The external storage 114 stores application programs, an operating system (OS), and various items of data.

In this embodiment, the CPU 111 performs processes according to the codes of the programs stored in the ROM 112 to execute the functions of the host computer 101 and the processes of the flowcharts, described below.

### Scanning Device

A scanning device 102 is an example of an image reading device. The scanning device 102 is connected to the host computer 101 via an input/output interface 198 of the scanning device 102 and the input/output interface 116 of the host computer 101. The input/output interface 198 of the scanning device 102 (image reading device) and the input/output interface 116 of the host computer 101 may be connected via a wired or wireless network.

The scanning device 102 includes a CPU 191, a ROM 192, a RAM 193, an operating unit 194, a reading unit 195, a printing unit 196, a NETIF 197, and the input/output interface 198.

The CPU 191 controls the scanning device 102 as a whole.

The ROM 192 is a memory that stores programs.

The RAM 193 is a memory that temporarily stores the programs and image data. The reading unit 195 is a scanner, which reads images of documents.

The printing unit 196 prints images on sheets based on image data. The printing unit 196 is not an absolute necessity.

The NETIF 197 is a network interface that performs control for data transfer to/from an external device. The image processing unit 190 performs various image editing processes on the input image data.

Here, the host computer 101 and the scanning device 102 are separately configured, but they may be configured as a single information processing apparatus. The scan settings screen and the advanced-settings screen, described below, are displayed on the display unit 119. In this embodiment, the scanning device 102 will be described using an electrophotographic digital multifunction device having multiple functions, such as copying, printing, and faxing, as an example. This is however illustrative only. This embodiment is also applicable to devices that use an ink-jet method or other processes and scanners that read only images. The host computer 101 may be a desktop personal computer, a smartphone, or a notebook personal computer.

### Software Configuration of Scanning System

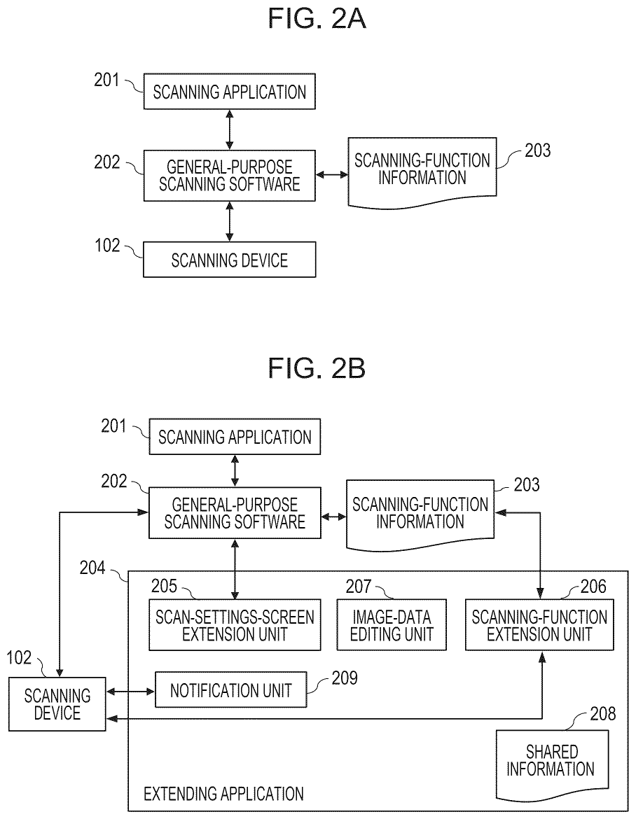

FIGS. 2A and 2B illustrate the software configuration of the scanning system. The software configuration in FIGS. 2A and 2B is stored in the external storage 114 of FIG. 1. Here, the explanation is based on a scanning system that uses the host computer 101 equipped with Microsoft® Windows® 11 as its OS. The OS includes (comes with) general-purpose scanning software 202. When the OS is installed on the host computer 101, the general-purpose scanning software 202 becomes available for use.

FIG. 2A is a diagram illustrating a general configuration in which an extending application 204 is not associated with the general-purpose scanning software 202 and the scanning device 102.

FIG. 2B is a diagram illustrating a configuration in which the extending application 204 is associated with the general-purpose scanning software 202 and the scanning device 102.

### Without Extending Application

First, the configuration of the scanning system in the case where the extending application 204 is not associated will be described with reference to FIG. 2A.

The scanning application 201 is software for importing scanned content (image data). Examples include a document creation application and an image editing application. In response to receiving a scan request from the user, the scanning application 201 issues scan instructions to the OS. The scan instructions include scan settings information to specify the operations of the general-purpose scanning software 202 and the scanning device 102.

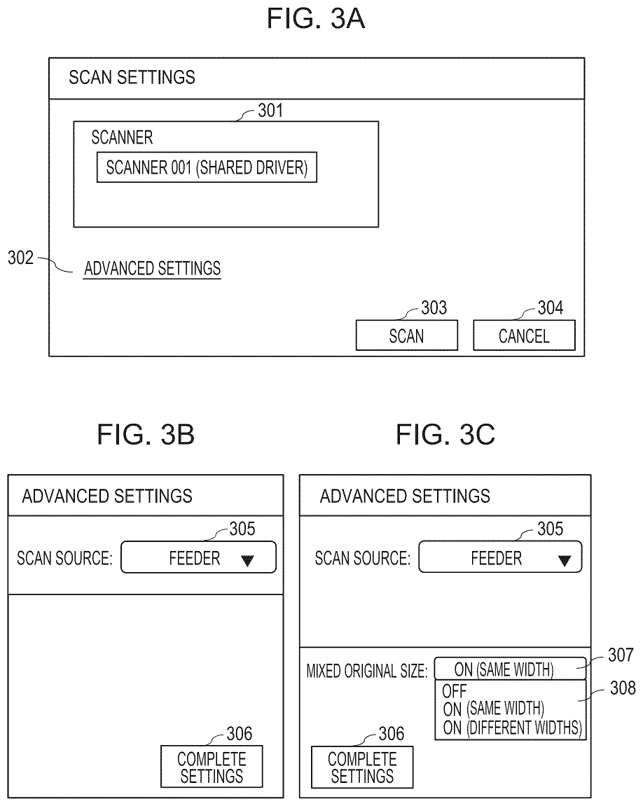

The scanning application 201 can display a scan-settings screen provided by the general-purpose scanning software 202, the OS, or the scanning application 201 to execute the scan instructions. When “advanced settings” in the scan-settings screen is pressed, the general-purpose scanning software 202 additionally displays an advanced-settings screen. The scan-settings screen and the advanced-settings screen will be described below with reference to FIGS. 3A to 3C. The advanced-settings screen includes setting items indicating configurable scanning functions (hereinafter referred to as “control items”) and control items indicating their setting values according to the capability information (configurable information) from the general-purpose scanning software 202. The general-purpose scanning software 202 determines the scan capability based on scanning function information 203.

The scanning function information 203 is data that indicates scanning functions including all configurable scanning functions, their setting values, and the exclusion relationship among the setting values. The scanning function information 203 is included in the configuration file of the general-purpose scanning software 202 and is placed in the external storage 114 as an unchangeable file. Alternatively, the scanning function information 203 may be dynamically generated by the general-purpose scanning software 202. Specifically, the general-purpose scanning software 202 or the OS may be configured to obtain the attribute data of the scanning device from the scanning device 102 and generate the scanning function information 203 according to the attribute information in the obtained attribute data. The scanning function information 203, if dynamically generated, can be edited. The attribute data of the scanning device obtained from the scanning device 102 includes attribute information indicating functions that can be specified by the scanning device 102 (the capability of the scanning device 102) and setting values related to the attribute information. This information is stored in the RAM 113.

This configuration of the general-purpose scanning software 202 allows the user to specify scanning functions available across all the scanning devices 102 according to the connected scanning device 102. In other words, even if a scanning device with different functions or a scanning device developed by a different vendor is connected, the general-purpose scanning software 202 allows the user to specify available scanning functions according to the connected scanning device. The vendor may be the manufacturer of the scanning device 102. Here, the general-purpose scanning software 202 is a standard-class driver for executing scanning operations based on a standard scan protocol called Mopria. The general-purpose scanning software 202 obtains the capability information of the connected scanning device 102 (image reading device) so that the user can specify scanning functions supported by the connected scanning device 102 and generates the scanning function information 203 based on the information. However, the general-purpose scanning software 202 does not support a mixed document size function. This is because the mixed document size function is a unique function of scanning device vendors (or scanning device manufacturers).

### Mixed Document Size Function

The mixed document size function enables the scanner to simultaneously read multiple documents of different sizes through the feeder, generating scanned image data according to the size of each scanned document. By using this function, multiple documents can be scanned without the need to reposition them on the feeder according to their sizes, thereby obtaining appropriately sized image data.

Although this embodiment shows an example of selecting and setting one of the three patterns: Mixed OFF, Mixed ON (documents with the same width), and Mixed ON (documents with different widths) is selected, the setting of this function is not limited to this method. Another example is a pattern that allows only specific document sizes to be mixed (for example, a mix of letter (LTR) size and legal (LGL) size documents), depending on the properties of the feeder. Alternatively, only two patterns, Mixed OFF and Mixed ON (documents with the same width), may be configurable.

### With Extending Application

Next, the configuration of the scanning system in the case where the extending application 204 is associated will be described with reference to FIG. 2B. Any configurations and processes not specifically mentioned are of the same configuration as in FIG. 2A.

The extending application 204 is software for extending or supporting the functions of the general-purpose scanning software 202 and is not contained (packed) in advance in the OS. For this reason, the user needs to operate the host computer 101 to download the extending application 204 from the server via the Internet and install it. Alternatively, the extending application 204 may be automatically installed in response to connection of the scanning device 102 to the host computer 101. Specifically, when the scanning device 102 is connected to the host computer 101, the OS obtains device identification information from the scanning device 102. The OS may download the extending application 204 corresponding to the obtained device identification information from the server via the Internet, and install it. In other words, the general-purpose scanning software 202 and the extending application 204 are stored in the host computer 101 as different files.

The general-purpose scanning software 202 and the extending application 204 may be updated and version-upgraded, but these update processes are carried out at separate times. In other words, the timing of when the general-purpose scanning software 202 is obtained and the timing of when the extending application 204 by the host computer 101 is obtained are different. The trigger to obtain the general-purpose scanning software 202 and the trigger to obtain the extending application 204 by the host computer 101 are also different. When the extending application 204 is installed, the OS associates the extending application 204 with the general-purpose scanning software 202 and the scanning device 102.

The extending application 204 described in this embodiment includes a scan-settings-screen extension unit 205, a scanning-function extension unit 206, an image-data editing unit 207, and a notification unit 209. The extending application 204 further includes shared information 208 accessible from each unit. The actual form of the shared information 208 is a file stored in the external storage 114 or information stored on the RAM 113. The extending application 204 writes and reads information to/from the shared information 208 by using an application program interface (API) provided by the OS.

The extending application 204 may terminate the operation every time the process of each unit is completed. In that case, the OS starts the extending application 204 every time a request to use the unit is provided.

Furthermore, the extending application 204 may cancel the process of each unit during the process. If the process is cancelled, the job being processed is deleted by the OS.

In response to receiving a scan request from the user, the scanning application 201 issues scan instructions to the OS. Also in this configuration, the scanning application 201 can display a scan-settings screen, as with the configuration of FIG. 2A. In this configuration, an advanced-settings screen provided by the extending application 204 is displayed. Specifically, an advanced-settings screen provided by the scan-settings-screen extension unit 205 of the extending application 204 is displayed. The scan-settings-screen extension unit 205 can store advanced settings set by the user in the shared information 208.

The image-data editing unit 207 obtains image data from the scanning device 102 and edits the image data. The image-data editing unit 207 obtains advanced settings information from the shared information 208 and edits the image data according to the advanced settings. The extending application 204 may be configured to obtain image data obtained by the general-purpose scanning software 202 and edit the image data according to the advanced settings. Also, in the configuration of FIG. 2B, the user may not perform a mixed document size setting. In this case, the general-purpose scanning software 202 may issue a scan request instruction to the scanning device 102 without passing through the extending application 204, as in the configuration of FIG. 2A.

The scanning-function extension unit 206 can edit the scanning function information 203 generated by the general-purpose scanning software 202 or the OS. For this reason, the scanning-function extension unit 206 can add functions provided by the extending application 204. The scanning-function extension unit 206 can also add a function that is supported by the scanning device 102 by is not supported by the general-purpose scanning software 202 (a mixed document size function), the exclusion relationship among the setting values of the scanning functions, and so on. When the extending application 204 is first associated with the scanning device 102 and the general-purpose scanning software 202, the OS starts the scanning-function extension unit 206. The OS may start the scanning-function extension unit 206 when the OS is started or at another time.

The notification unit 209 can display a notification to the user in response to the occurrence of an error in the scanning device 102. For example, when a scan jam error occurs in the scanning device 102, the general-purpose scanning software 202 detects it, and the OS causes the display unit 119 to display a message using a notification function called a toast notification, which is a function of the OS. When the toast notification is pressed by the user, the notification unit 209 of the extending application 204 is invoked by the OS, and the user interface (UI) screen of the notification unit 209 is displayed. On the UI screen of the notification unit 209, for example, a scan jam error detailed message or a jam clear method can be displayed.

The configuration of the extending application 204 for implementing this embodiment is not limited to one that includes all of the above-described functions (units) and may include only some of the functions or additional functions. The extending application 204 may also be simply referred to as scanning software. The extending application 204 may include at least one of the following functions. The first is a function to display a scan settings screen (the scan-settings-screen extension unit 205). The second is a function to edit image data according to advanced settings (the image-data editing unit 207). The third is a function to extend functions that can be specified by image data generating software (the scanning-function extension unit 206). The fourth is a function to display a screen in response to the occurrence of an error in the scanning device 102 (the notification unit 209).

### Example of Scan-Settings Screen/Advanced-Settings Screen

Next, examples of the scan-settings screen and the advanced-settings screen of this embodiment will be described with reference to FIGS. 3A to 3C. FIG. 3A illustrates a scan-settings screen displayed by the scanning application 201. FIG. 3B illustrates an advanced-settings screen displayed in the case of the configuration without the extending application 204, illustrated in FIG. 2A. FIG. 3C illustrates an advanced-settings screen displayed in the case of the configuration with the extending application 204 illustrated in FIG. 2B. The units or modules for displaying the scan-settings screen are not limited to those described above. For example, the scan-settings-screen extension unit 205 may be configured only to generate a display screen. In that case, the scan-settings-screen extension unit 205 sends the generated display screen to the scanning application 201 via the general-purpose scanning software 202. The scanning application 201 may be configured to display the obtained display screen.

### Scan-Settings Screen (Scanning Application)

FIG. 3A illustrates a scan-settings screen displayed by the scanning application 201.

A control 301 includes objects for causing the user to set a scanner to be used to scan image data (a scanner to be used for scanning).

A control 302 is an advanced settings button. When the control 302 is pressed, an additional scan screen is displayed by the general-purpose scanning software 202 or the scan-settings-screen extension unit 205.

A control 303 is a scan start button. A control 304 is a scan cancel button.

### Advanced-Settings Screen (General-Purpose Scanning Software)

FIG. 3B illustrates an advanced-settings screen displayed by the general-purpose scanning software. The advanced-settings screen in FIG. 3B is an additional setting screen displayed by the general-purpose scanning software 202 in the case without the extending application 204. A control 305 allows the scan source to be set and indicates that the feeder is selected. A control 306 is a settings completion button. When the control 306 is pressed, the screen returns to the scan-settings screen illustrated in FIG. 3A.

### Advanced-Settings Screen (Extending Application)

FIG. 3C illustrates an advanced-settings screen displayed by the scan-settings-screen extension unit 205.

The advanced-settings screen of FIG. 3C is an additional setting screen displayed by the scan-settings-screen extension unit 205 in the configuration with the extending application 204. Unlike FIG. 3B, a control 307 and a list 308 are added.

The control 307 is a button that allows a mixed document size setting for the scanner to be selected, indicating that “ON (documents with the same width)” is selected.

The list 308 is displayed when the control 307 is pressed, indicating the setting value of the mixed document size setting. The list 308 indicates that, in addition to the currently selected “ON (documents with the same width)”, there are settings for “OFF” (=mixed document size) and “ON (documents with different widths)”. The user switches the mixed document size function for scanning by selecting a desired setting from the list 308.

In FIG. 3C, since the scan source is the feeder as indicated by the control 305, settings other than “OFF” can be selected for the mixed document size setting. However, when a scan source other than the feeder, for example, the platen glass, is selected, only the “OFF” setting can be chosen for the mixed document size setting. This is because the mixed document size function can only be implemented with a feeder that automatically feeds multiple documents. For this reason, when a scan source other than the feeder is selected, the setting values other than “OFF” in the list 308 are grayed out so as not to be selected (not shown), though the control 307 and the list 308 in FIG. 3C are displayed.

The reason why the scan setting items differ between FIG. 3B and FIG. 3C will be described. The advanced-settings screen is generated with reference to scan capability generated based on the scanning function information 203.

However, since the general-purpose scanning software 202 does not support the mixed document size function, the mixed document size function cannot be added to the scanning function information 203. Even if the scanning function information 203 originally includes the mixed document size function, the general-purpose scanning software 202 cannot interpret the mixed document size function included in the scanning function information 203, and therefore, the mixed document size setting cannot be displayed on the advanced-settings screen. However, the scanning-function extension unit 206 can add the mixed document size function to the scanning function information 203, and the scan-settings-screen extension unit 205 can display the advanced-settings screen with reference to the scan capability.

This configuration enables the extending application 204 to display the mixed document size setting on the advanced-settings screen. FIG. 3C may additionally include extended functions other than the mixed document size function.

### Scanning-Function-Information Editing Process

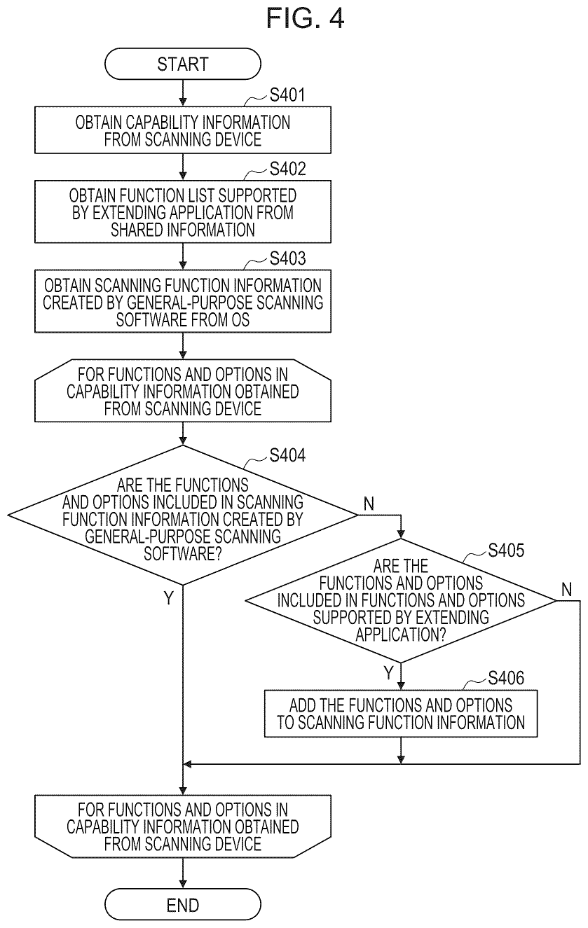

Referring next to FIG. 4, a processing procedure for the scanning-function extension unit 206 to edit the scanning function information 203 will be described. The individual steps are carried out by the CPU 111 executing units that are read from the external storage 114 into the RAM 113.

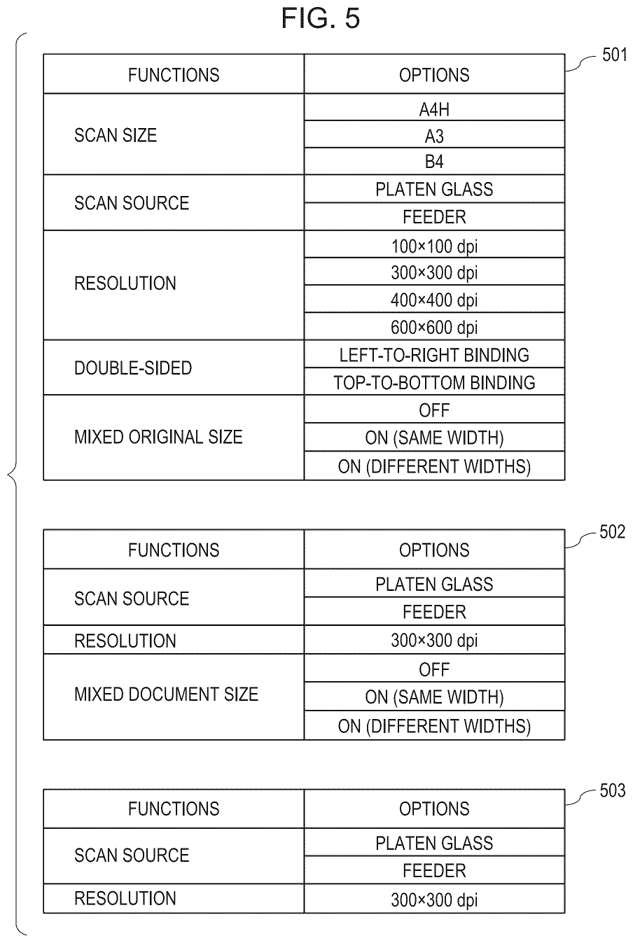

In S401, first, the scanning-function extension unit 206 obtains capability information from the scanning device 102. The capability information includes attribute information indicating the functions that can be specified by the scanning device 102 and setting values related to the attribute information. Capability information 501 in FIG. 5 shows an example of a list of capability information obtained from the scanning device 102. As shown in the capability information 501, functions such as scan size instructions and options that are configurable to the functions can be obtained from the scanning device 102.

Next, in S402, the scanning-function extension unit 206 obtains a list of scanning functions supported by the extending application 204 from the shared information 208. The list of scanning functions supported by the extending application 204 is stored in the shared information 208 and includes all scanning functions that can be processed by the extending application 204 and their setting values. Scanning functions 502 in FIG. 5 show an example of a list of scanning functions supported by the extending application 204. The list of scanning functions supported by the extending application 204 may be updated by updating the extending application 204.

Next, in S403, the scanning-function extension unit 206 obtains the scanning function information 203 created by the general-purpose scanning software 202 from the OS. Scanning functions 503 in FIG. 5 show an example of a list of scanning functions supported by the general-purpose scanning software 202.

The scanning function information 203 created by the general-purpose scanning software 202 is created based on the capability information 501 that is obtained by the general-purpose scanning software 202 from the scanning device 102. The scanning function information 203 created by the general-purpose scanning software 202 includes, among the capability information obtained from the scanning device 102, only the scanning functions supported by the general-purpose scanning software 202. For this reason, the functions of the scanning function information 203 are limited. For example, the capability information 501 obtained from the scanning device 102 includes the mixed document size function, whereas the general-purpose scanning software 202 does not support the document size function, and the scanning function information 203 does not include the mixed document size function. By adding functions and options to the scanning function information 203 through the scanning-function extension unit 206, the extending application 204 can compensate for the functional limitations of the general-purpose scanning software 202. The scanning-function extension unit 206 can also delete unnecessary functions and options from the scanning function information 203 created by the general-purpose scanning software 202.

The following steps S404, S405, and S406 are repeated for the list of functions in the capability information obtained from the scanning device in S401. In this embodiment, the processes are repeated for the 14 options included in the capability information 501, Scan size: A4H to Mixed document size: ON (documents with different widths).

First, in S404, the scanning-function extension unit 206 determines whether the functions and the options being processed are included in the scanning function information 203 created by the general-purpose scanning software 202. If the functions and options being processed are included in the scanning function information 203 (Yes in S404), the scanning-function extension unit 206 moves to the next item in the functions and options of the capability information obtained from the scanning device 102. If the last item of the functions and options of the capability information obtained from the scanning device 102 is being processed, the CPU 111 terminates the flowchart of FIG. 4. In contrast, the function and option being processed are not included in the scanning function information 203 (No in S404), the CPU 111 proceeds to S405.

For example, since Scan source: platen glass in the capability information 501 of the scanning device 102 is included also in the scanning functions 503 of the general-purpose scanning software 202, it is determined as Yes. In contrast, Scan size: A4H in the capability information 501 is not included in the scanning functions 503, and therefore, it is determined as No, and the process proceeds to S405.

Next, in S405, the scanning-function extension unit 206 determines whether the functions and options being processed are included in the functions and options supported by the extending application 204. If the functions and options being processed are included in the functions and options supported by the extending application 204 (Yes in S405), the CPU 111 proceeds to S406. In contrast, if the functions and options being processed are not included (No in S405), the scanning-function extension unit 206 moves to the next item in the functions and options of the capability information obtained from the scanning device 102. If the last item of the functions and options of the capability information obtained from the scanning device 102 is being processed, the CPU 111 terminates the flowchart of FIG. 4.

In this embodiment, for example, if the function being processed is “Mixed document size: ON (documents with the same widths)”, the function is included also in the scanning functions 502 of the extending application 204, and therefore, it is determined as Yes, and the process proceeds to S406.

In S406, the scanning-function extension unit 206 adds the function and option being processed to the scanning function information 203. After completion of the process of S406, the CPU 111 performs S404 again or terminates the processing of the flowchart of FIG. 4, just as when it is determined as Yes in S404.

Thus, the scanning-function extension unit 206 adds the functions and options that are not supported by the general-purpose scanning software 202 and are supported by the scanning device 102 and the extending application 204 to the scanning function information 203. Scan capability is generated based on the scanning function information 203 edited through this processing. Furthermore, the scan-settings-screen extension unit 205 can extend functions that are not supported by the general-purpose scanning software 202 and display the advanced-settings screen illustrated in FIG. 3C by generating a display screen based on the generated scan capability.

Process of Scanning Application (after Accepting Scan Settings)

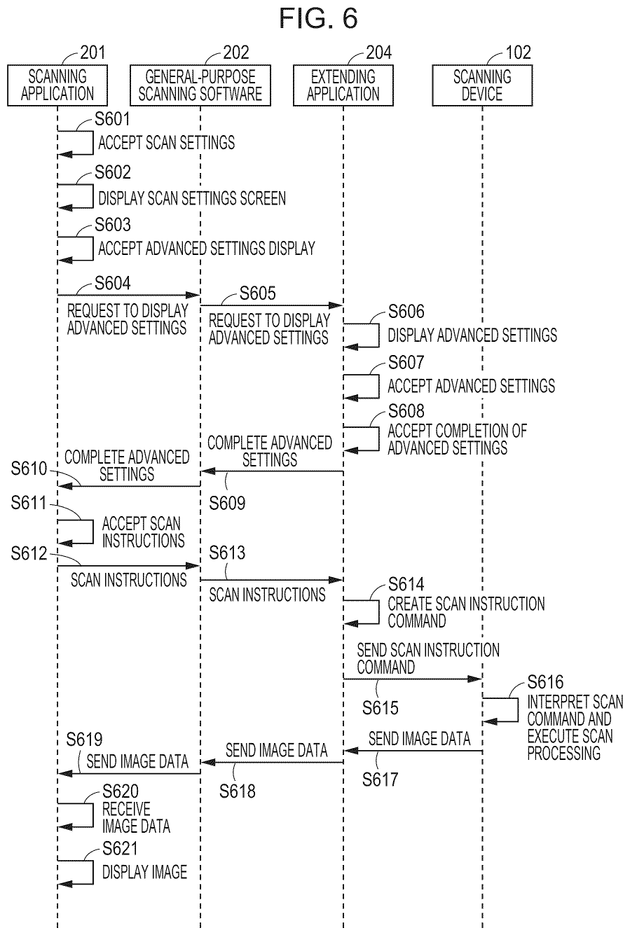

Referring to FIG. 6, the sequence performed by the scanning application 201, the general-purpose scanning software 202, the extending application 204, and the scanning device 102 after the scanning application 201 accepts scan settings will be described. The steps other than those of the scanning device 102 in FIG. 6 are performed by the CPU 111 reading the scanning application 201, the general-purpose scanning software 202, and the extending application 204 from the external storage 114 into the RAM 113 and executing them. The steps of the scanning device 102 in FIG. 6 are implemented by the CPU 191 of the scanning device 102 reading the programs stored in the ROM 192 or the external storage 199 into the RAM 193 and executing them.

In S601, the scanning application 201 accepts scan settings from the user.

The user can instruct the scanning application 201 to configure scan settings by operating the pointing device 117 or the keyboard 118.

In S602, the scanning application 201 displays the scan-settings screen illustrated in FIG. 3A on the display unit 119.

In S603, the scanning application 201 accepts an advanced settings instruction. The user can provide the advanced settings instruction by operating the pointing device 117 or the keyboard 118 to select the control 302.

In S604, the scanning application 201 requests the general-purpose scanning software 202 to display advanced settings.

In S605, the general-purpose scanning software 202 requests the extending application 204 to display the advanced settings. In the case of the configuration of FIG. 2B, the general-purpose scanning software 202 displays the advanced-settings screen of FIG. 3C, as described above.

In S606, the scan-settings-screen extension unit 205 of the extending application 204 displays the advanced-settings screen of FIG. 3C on the display unit 119. This is because the mixed document size setting is added to the scanning function information 203 by the scanning-function extension unit 206 as illustrated in FIG. 4. The scan-settings-screen extension unit 205 displays the advanced-settings screen of FIG. 3C on the display unit 119 with reference to the scan capability generated based on the scanning function information 203 after the addition. In this embodiment, since the resolution supported by the extending application 204 is limited to a single type, 300×300 dpi, there is no need for the user to make a selection, and the resolution is not displayed on the advanced settings screen. Even such non-selectable items may be displayed on the advanced-settings screen to inform the user explicitly.

In S607, the scan-settings-screen extension unit 205 accepts the advanced settings. In this embodiment, “Scan source: feeder” and “Mixed document size: ON (documents with the same width)” are selected by the user, as illustrated in FIG. 3C. The accepted settings are stored in the RAM 113 by the CPU 111.

Next, in S608, the scan-settings-screen extension unit 205 accepts completion of the advanced settings and writes the accepted settings into the scan settings information. The user can provide an instruction to terminate the advanced settings by operating the pointing device 117 or the keyboard 118 to select the control 306. Items that are not selected by the user, such as the resolution, may be written together when the scan settings are written to the scan settings information.

In S609, the extending application 204 sends completion of the advanced settings to the general-purpose scanning software 202.

In S610, the general-purpose scanning software 202 sends the completion of the advanced settings to the scanning application 201.

In S611, the scanning application 201 accepts scan instructions. The user can provide the scan instructions by selecting the control 303 with the pointing device 117 or the keyboard 118.

In S612, the scanning application 201 provides the scan instructions to the general-purpose scanning software 202.

In S613, the general-purpose scanning software 202 provides the scan instructions to the extending application 204.

In S614, the extending application 204 creates a scan instruction command based on the scan settings information written in S608. If in S608 items that are not selected by the user, such as resolution, are not written to the scan settings information, the extending application 204 may add the items when creating the scan instruction command in S614. Alternatively, the scanning device 102 may be operated with its default value without adding the items.

In S615, the extending application 204 sends the scan instruction command to the scanning device 102 to initiate scanning.

In S616, the scanning device 102 interprets the scan instruction command and executes a scan.

During execution of the scan, necessary image processing according to the scan instructions is performed on the image data.

In this embodiment, when the scan settings of FIG. 3C are performed, scan processing considering mixed document sizes is performed. In other words, for scanning, the document size is detected and scanning is performed according to the document size, generating image data.

In S617, the scanning device 102 sends the generated image data to the extending application 204.

In S618, the extending application 204 sends the received image data to the general-purpose scanning software 202.

In S619, the general-purpose scanning software 202 sends the received image data to the scanning application 201.

In S620, the scanning application 201 receives the image data.

In S621, the scanning application 201 displays the received image data.

### Scan Processing (Extending Application)

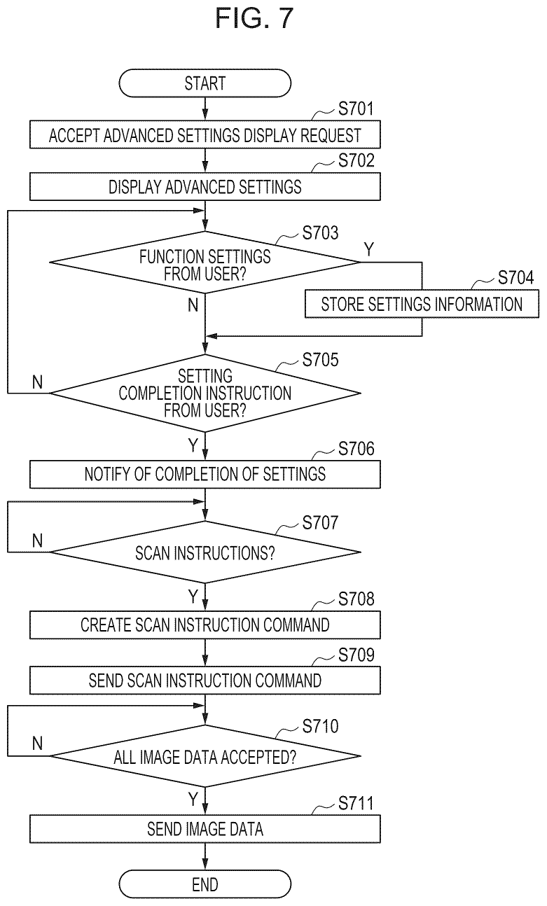

The procedure of scan processing executed by the extending application 204 will be described with reference to FIG. 7. The steps are implemented by the CPU 111 executing units that are read from the external storage 114 into the RAM 113.

In S701, the extending application 204 accepts a request to display advanced settings.

In S702, the scan-settings-screen extension unit 205 of the extending application 204 displays the advanced-settings screen of FIG. 3C on the display unit 119. This is because the mixed document size setting is added to the scanning function information 203 by the scanning-function extension unit 206 as illustrated in FIG. 4.

The scan-settings-screen extension unit 205 displays the advanced-settings screen of FIG. 3C on the display unit 119 with reference to the scan capability generated based on the scanning function information 203 after the addition.

In S703, the scan-settings-screen extension unit 205 determines whether any functions have been configured by the user. If some functions have been configured (Yes in S703), the CPU 111 proceeds to S704.

In S704, the advanced settings are accepted and stored in the RAM 113 by the CPU 111.

In contrast, if no functions are configured (No in S703), the CPU 111 proceeds to S705.

In S705, the scan-settings-screen extension unit 205 determines whether a setting completion instruction has been provided by the user. If a setting completion instruction has been provided (Yes in S705), the scan-settings-screen extension unit 205 accepts the completion of the advanced settings and writes the accepted settings in the scan settings information. If no setting completion instruction has been provided by the user (NO in S705), then the scan-settings-screen extension unit 205 returns to S703 and determines whether any functions have been configured by the user.

In S706, the extending application 204 sends the completion of the advanced settings to the general-purpose scanning software 202.

In S707, the extending application 204 determines whether scan instructions have been provided by the general-purpose scanning software 202. If scan instructions have been provided (Yes in S707), the CPU 111 proceeds to S708; otherwise (No in S707) the CPU 111 returns to S707 waits.

In S708, the extending application 204 creates a scan instruction command based on the scan settings information written in S705.

An example of how to create the scan instruction command is a method in which a standard protocol command is extended. An example of the extension method is to specify a dedicated command in the extended area of the standard protocol command. Other examples include a method in which a proprietary protocol command is added to the tail end of a standard protocol command and a method in which the extending application 204 overwrites the standard protocol command with a proprietary command system.

If the instructions are provided by the extending application 204, instructions and communication may be carried out using a vendor's proprietary protocol without reference to the standard protocol.

Next, in S709, the extending application 204 sends the scan instruction command to the scanning device 102 to initiate scanning.

Next, in S710, the extending application 204 determines whether all image data has been accepted from the scanning device 102. If all image data has been received from the scanning device 102 (Yes in S710), the CPU 111 proceeds to S711; otherwise (No in S710), the CPU 111 returns to S710 and waits.

In S711, the extending application 204 sends the received image data to the general-purpose scanning software 202.

### Process of Scanning Device

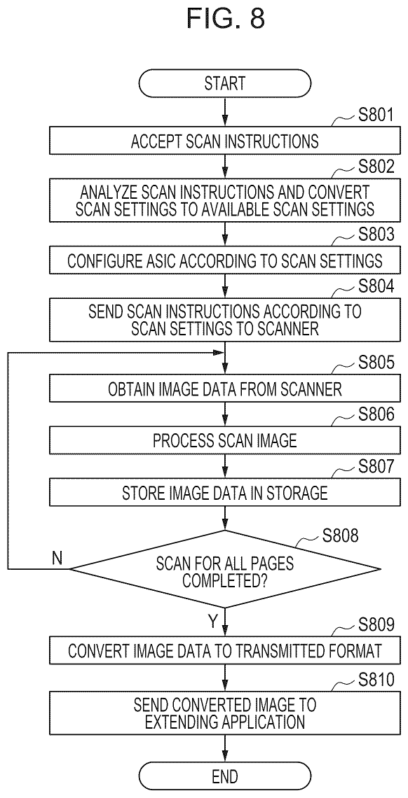

Referring to FIG. 8, the procedure of scan processing executed by the scanning device 102 that has received the scan instructions from the extending application 204 will be described with reference to FIG. 8. The steps of the flowchart of FIG. 8 are implemented by the CPU 191 executing the programs stored in the RAM 193.

In S801, the CPU 191 accepts scan instructions sent from the extending application 204.

In S802, the CPU 191 analyzes the scan instruction command accepted in S801 and converts the scan settings to scan settings with which the scanning device 102 can perform scan processing. In this embodiment, the scan settings are “Feeder, Mixed document size: ON (documents with the same widths), and Resolution: 300×300 dpi”.

In S803, the CPU 191 determines an application specific integrated circuit (ASIC) for the image processing unit 190 to be used to execute the scanning according to the scan settings converted in S802 and configures the ASIC.

In S804, the CPU 191 sends scan instructions according to the scan settings to the reading unit 195. In this embodiment, the CPU 191 sends instructions to perform scanning on the feeder, with the scan settings “Mixed document size: ON (documents with the same widths)”. In response to the instructions, the reading unit 195 detects the document size and performs a scanning operation with an appropriate scan size.

In S805, the CPU 191 obtains image data from the reading unit 195.

In S806, the CPU 191 and the image processing unit 190 execute image processing on the received image data. In this embodiment, the resolution of the image data is converted to 300×300 dpi. If the reading unit 195 can scan with 300×300 dpi, the reading unit 195 may obtain the image data with a resolution of 300×300 dpi, and the image processing does not need to be executed in S806.

In S807, the CPU 191 stores the image data in the external storage 199.

In S808, the CPU 191 determines whether the scan processing for all pages has been completed. If the CPU 191 determines that the scan processing has not been completed, the CPU 191 returns to S805 and executes the scan processing of the next page. If the CPU 191 determines that the scan processing has been completed, the CPU 191 proceeds to S809.

In S809, the CPU 191 and the image processing unit 190 convert the image data stored in S807 according to the transmitted format settings accepted in S801. In this embodiment, the transmitted format is not included in the scan instructions accepted from the extending application 204. For this reason, the image data is converted to the default joint photographic experts group (JPEG) of the scanning device 102. However, the transmitted format for conversion is not limited to this; any format that can be supported by the information processing apparatus is acceptable.

In S810, the converted image data is sent to the extending application 204, and all the processes end. The image data sent to the extending application 204 is scanned with an appropriate size for each page, resulting in different image sizes.

As described above, in this embodiment, the scan-settings-screen extension unit 205 of the extending application 204 corrects the scanning function information 203 based on the capability information from the general-purpose scanning software 202, the extending application 204, and the scanning device 102. When an advanced-settings screen is requested from the user, a settings screen is displayed based on the scan capability generated from the scanning function information 203, allowing the user to configure the mixed document size setting. Thereafter, upon receiving scan instructions that reflect the mixed document size setting, the scanning device 102 executes the mixed document size function for scanning. Through the above series of processes, the scanning device 102 can implement the mixed document size function, allowing the user to perform the mixed document size function. The use of this function allows multiple documents to be scanned without replacing them on the feeder for each size, providing image data with an appropriate size.

Although this embodiment has been described using the advanced-settings screen illustrated in FIG. 3C with the configuration of FIG. 2B, the present disclosure is not limited to this embodiment. For example, when in S604 an advanced-settings display request is issued to the general-purpose scanning software 202, the general-purpose scanning software 202 may display the advanced-settings screen illustrated in FIG. 3B. Next, after completion of the advanced settings of FIG. 3B, the general-purpose scanning software 202 requests the extending application 204 to display an additional advanced-settings screen. Next, the extending application 204 may additionally display an advanced-settings screen in which the mixed document size setting can be configured.

Although the scan instructions to the extending application 204 are provided from the general-purpose scanning software 202, this is illustrative only. Other examples include a method in which the instructions are provided from the scanning application 201 to the extending application 204 and a configuration in which a control for scan instructions is disposed on the advanced-settings screen so that the user can directly provide instructions to the extending application 204. The image data may be directly passed from the extending application 204 to the scanning application 201 not via the general-purpose scanning software 202 or may be passed from the scanning device 102 to the scanning application 201. The accepted image data may be stored in the external storage 114, with only the file path information of the storage being passed along.

In this embodiment, when multiple pieces of image data are involved, all the image data is accepted and then passed along at once. Alternatively, transmitted image data may be passed along at any time.

### Second Embodiment

A second embodiment of the present disclosure will be described hereinbelow. In the first embodiment, the extending application 204 and the scanning device 102 interact with each other.

In the second embodiment, the scanning device 102 communicates with the general-purpose scanning software 202. The extending application 204 performs only the extension of scan commands and image editing.

Only the difference from the first embodiment will be described hereinbelow.

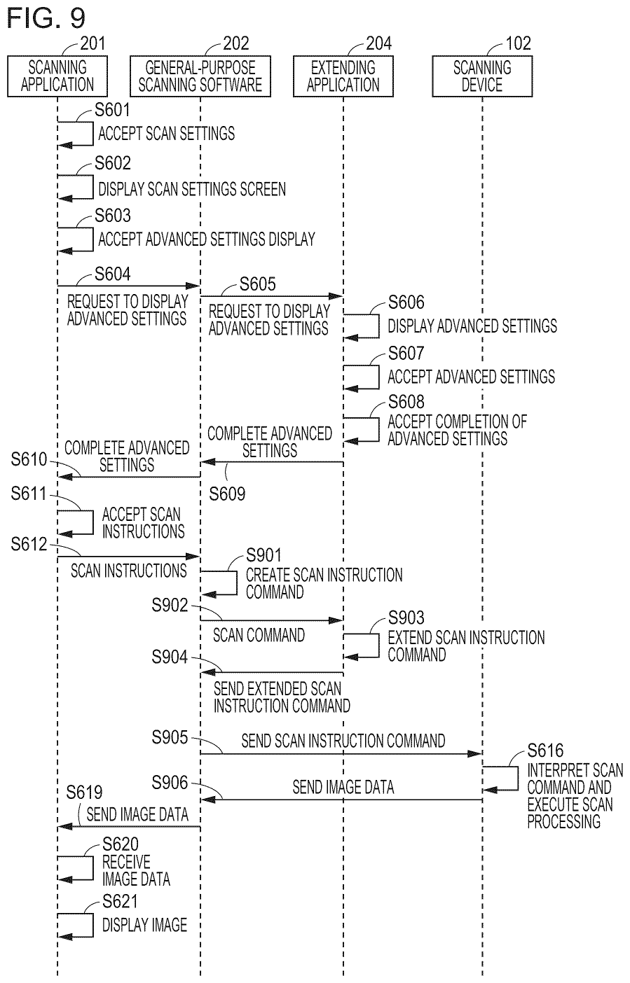

Referring to FIG. 9, the sequence performed by the scanning application 201, the general-purpose scanning software 202, the extending application 204, and the scanning device 102 after the scanning application 201 accepts scan settings will be described. The steps other than those of the scanning device 102 in FIG. 9 are performed by the CPU 111 reading the scanning application 201, the general-purpose scanning software 202, and the extending application 204 from the external storage 114 into the RAM 113 and executing them. The steps of the scanning device 102 in FIG. 9 are implemented by the CPU 191 of the scanning device 102 reading the programs that are stored in the ROM 192 or the external storage 199 into the RAM 193 and executing them.

The sequence after the general-purpose scanning software 202 accepted the scan instructions in S612 will be described.

In S901, the general-purpose scanning software 202 creates a scan instruction command. At that time, the scan instruction command does not include functions that are not supported by the general-purpose scanning software 202.

In S902, the general-purpose scanning software 202 sends the created scan instruction command to the extending application 204.

In S903, the extending application 204 adds instructions for the functions that are not supported by the general-purpose scanning software 202 to the received scan instruction command and changes the existing instructions to extend the command. In this embodiment, since the scan instruction command created by the general-purpose scanning software 202 in S901 does not include the mixed document size setting, the extending application 204 adds the mixed document size setting.

In S904, the extending application 204 sends the extended scan instruction command to the general-purpose scanning software 202.

In S905, the general-purpose scanning software 202 sends the scan instruction command to the scanning device 102 to initiate scanning.

In S906, the general-purpose scanning software 202 receives the image data from the scanning device 102.

As described above, in this embodiment, by extending the mixed document size command through the extending application 204, the scanning device 102 can implement the mixed document size function, thereby providing the mixed document size function to the user.

### Third Embodiment

A third embodiment of the present disclosure will be described hereinbelow. In the first and second embodiments, the command used in the standard protocol is extended and is transferred to the scanning device 102.

In the third embodiment, the command used in the standard protocol is not extended; functions supported only by the extending application 204 are transferred to the scanning device 102 using another command.

Only the difference from the first and second embodiments will be described hereinbelow.

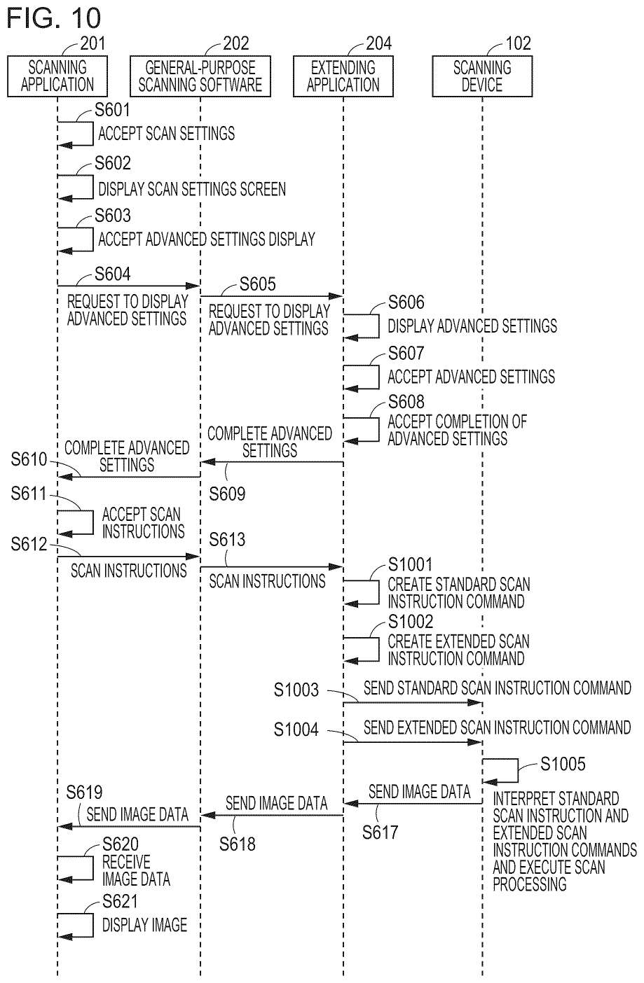

Referring to FIG. 10, the sequence performed by the scanning application 201, the general-purpose scanning software 202, the extending application 204, and the scanning device 102 after the scanning application 201 accepted scan settings will be described. The steps other than those of the scanning device 102 in FIG. 10 are performed by the CPU 111 reading the scanning application 201, the general-purpose scanning software 202, and the extending application 204 from the external storage 114 into the RAM 113 and executing them. The steps of the scanning device 102 in FIG. 10 are implemented by the CPU 191 of the scanning device 102 reading programs that are stored in the ROM 192 or the external storage 199 into the RAM 193 and executing them.

The sequence after the general-purpose scanning software 202 sends the scan instructions to the extending application 204 in S613 will be described.

In S1001, the general-purpose scanning software 202 creates a standard scan instruction command based on a standard protocol. At that time, the scan instruction command does not include functions that are not supported by the standard protocol.

In S1002, the extending application 204 creates an extended scan instruction command for functions supported only by the extending application 204.

In S1003, the extending application 204 sends the standard scan instruction command to the scanning device 102 to initiate scanning.

In S1004, the extending application 204 sends the extended scan instruction command to the scanning device 102 to initiate scanning.

In S1005, the scanning device 102 interrupts the scan instruction command and the extended scan instruction command received and executes scan processing.

### Scan Instruction Processing (Extending Application)

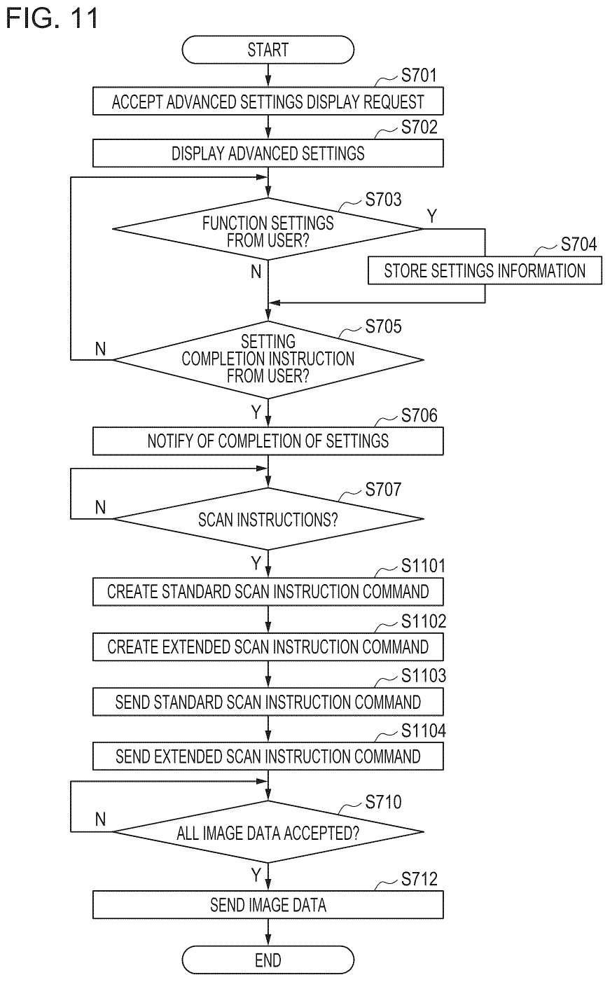

Next, the procedure of scan processing executed by the extending application 204 will be described with reference to FIG. 11. The steps are implemented by the CPU 111 executing units that are read from the external storage 114 into the RAM 113.

The processes different from those of FIG. 7 will be described. Specifically, the processes after the extending application 204 received scan instructions from the general-purpose scanning software 202 in S707 will be described.

In S1101, the extending application 204 creates a standard scan instruction command based on a standard protocol.

In S1102, the extending application 204 creates an extended scan instruction command for functions that are not supported by the standard protocol.

In S1103, the extending application 204 sends the standard scan instruction command created in S1101 to the scanning device 102.

In S1104, the extending application 204 sends the extended scan instruction command created in S1102 to the scanning device 102.

As described above, in the third embodiment, the mixed document size function can be provided to the user by sending another scan instruction command from the extending application for functions not supported by the standard protocol.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-052422, filed Mar. 27, 2024, which is hereby incorporated by reference herein in its entirety.

What is claimed is:

1. A non-transitory computer-readable storage medium storing an application program which causes an information processing apparatus to perform a control method, the application program supporting scanning software which is able to be used with a plurality of image processing apparatuses supplied from a plurality of manufacturers, the control method comprising:
displaying a display screen that accepts a mixed document size setting for scanning when a feeder is specified as a document scan source; and
outputting a scan instruction to an image reading device that executes scanning based on the setting accepted on the display screen.

2. The non-transitory computer-readable storage medium according to claim 1,
wherein, when a document scan source other than the feeder is specified,
the display screen is displayed so as not to select the mixed document size setting for scanning.

3. The non-transitory computer-readable storage medium according to claim 1,
wherein the display screen is capable of accepting the mixed document size setting in two or more patterns.

4. The non-transitory computer-readable storage medium according to claim 1,
wherein the display screen that accepts the mixed document size setting includes ON and OFF settings.

5. The non-transitory computer-readable storage medium according to claim 1,
wherein, when a scan instruction is issued to the image reading device that executes scanning, an instruction command is created by extending a standard protocol command.

6. The non-transitory computer-readable storage medium according to claim 5,
wherein, when a scan instruction is issued to the image reading device that executes scanning, the instruction command is created by adding an extended command to the standard protocol command.

7. The non-transitory computer-readable storage medium according to claim 5,
wherein, when a scan instruction is issued to the image reading device that executes scanning, a custom command structure is used to create the instruction command.

8. The non-transitory computer-readable storage medium according to claim 1,
wherein the display screen is displayed based on capability information on the image reading device.

9. The non-transitory computer-readable storage medium according to claim 1,
wherein, the scanning is executed by the image reading device with the mixed document size setting to generate image data with different image sizes for individual pages.

10. A method for controlling an information processing apparatus with a program installed to extend functionality of general-purpose scanning software which is able to be used with a plurality of image reading devices supplied from a plurality of manufacturers, the method comprising:
displaying a display screen that accepts a mixed document size setting for scanning when a feeder is specified as a document scan source; and
creating a scan instruction to an image reading device that executes scanning based on the setting accepted on the display screen.

11. An information processing apparatus with a program installed to extend functionality of general-purpose scanning software which is able to be used with a plurality of image reading devices supplied from a plurality of manufacturers, the apparatus comprising:
a display unit configured to display a display screen that accepts a mixed document size setting for scanning when a feeder is specified as a document scan source; and
a creation unit configured to create a scan instruction to an image reading device that executes scanning based on the setting accepted on the display screen.
